(19) United States
(12) Patent Application Publication
(10) Pub. No.: US 2005/0005373 A1
(43) Pub. Date: Jan. 13, 2005

(54) Methods for dyeing fibrous material, dyed goods produced by such methods, and a system for operating the method producing the goods

(75) Inventor: Norbert Buchel, Barrio Santiaguito (MX)

Correspondence Address: LACKENBACH SIEGEL, LLP, LACKENBACH SIEGEL BUILDING, 1 CHASE ROAD, SCARSDALE, NY, 10583, US

(73) Assignee: Colortex International, Inc., Oakhurst, NJ (US)

(21) Appl. No.: 10/879,908

(22) Filed: Jun. 29, 2004

Related U.S. Application Data
(60) Provisional application No. 60/485,098, filed on Jul. 3, 2003.

(51) Int. Cl. C09B 1/00

(52) U.S. Cl. 8/636

(57) ABSTRACT

A method for dyeing a fibrous material includes the steps of treating a fibrous material with a cationic agent and contacting said fibrous material with a direct dye. The treatment with a cationic agent may occur before or after the contact with a direct dye. Additional pre- and post-treatment steps may optionally include bleaching, neutralizing, fixing, and scouring to achieve an ultimately desired fibrous material look and feel.

### PRIORITY CLAIM

This application claims priority from Provisional Application Ser. No. 60/485,098 filed on Jul. 3, 2003, the contents of which are herein incorporated by reference.

### BACKGROUND OF THE INVENTION

1. Field Of The Invention

The present invention relates to a dyeing process for fibrous materials. More specifically, the present invention relates to a dyeing method for fibrous materials including a treatment with a cationic agent enabling improved dye adherence while enabling a desired wash-down capability

2. Description Of The Related Art

Various processes for producing “distressed,” “laundered” or “vintage” effects are known in the art, including processes using pigment dyes and sulfur dyes. Such processes, however, have not been used effectively, in large-scale dyeing machinery, such as jet machines, or on piece goods. Piece goods are fabrics that have not yet been cut or sewn into garments or formed into a final product such as sheets, pillows, etc. Rather, such techniques principally have been used only in garment dyeing. Garment dyeing is a process for dyeing garments that have already been cut and sewn into a generally final form.

Attempts to use pigment or sulfur techniques in large-scale dyeing machinery (jet machines) have been hampered by, among other things, unacceptable adherence or attachment of dye to the machines and the need to clean the machines. Furthermore, pigment dyes are not water-soluble providing substantial difficulty in the dyeing process. Pigment dyes cannot penetrate in the robe (into the individual fiber) in the fabric. Pigment dyes have no charge (e.g., are non-ionic). The dyestuff size (pigments) are too big for an even dyeing across an individual piece good or garment, and have no migration ability within an individual piece good or garment.

Pigment or sulfur dyeing technique also results in detrimental inconsistent coloring and are limited with the respect to range of colors that can be used. Many colors or chemicals that are used for pigment or sulfur dyeing contain formaldehyde and therefore cannot be marketed as “formaldehyde free” which is a growing concern in the American, European, and Asian markets, particularly for governmentally mandated formaldehyde-free markets, such as the boys-and girls' clothing markets. Additionally, pigment or sulfur dyed garments have mostly harsh had (feel), due to resins being needed within the dye process.

As a substantial additional concern, the colorfastness requirement for cocking, especially in wet crocking, is a problem in both pigments and sulfur. Those skilled in the art of fabric dyeing understand that “crocking” simply describes the transfer of color from one fabric onto another, generally white, test fabric. The more color is transferred, the more the fabric “crocks”.

There are various industry recognized tests for wet and dry crocking and color fastness know to those skilled in the art and so they are not discussed in detail here. The preferred test for “crocking” is done by AATCC Test Method 8, which is linear crocking. The Rotary Method, AATCC Test Method 116 may alternatively be used if necessary for certain patterns and stripes and selection of the method is within the skill of the practitioner.

One skilled in the art will also understand that dry and wet crocking may occur. Dry crocking is where there may be too much loose dye in the thread/yarn/fabric/textile, and the dye is transferred in a generally dry state to another thread/yarn/fabric/textile by generally physical means such as rubbing (back and forth motions), physical contact storage, or inter-garment sliding. One can test for dry crocking by rubbing a dry white thread/yarn/fabric/textile test against a dyed fabric and determining the amount of unintended dye transfer.

Wet crocking involves the transfer of dye from a first dyed thread/yarn/fabric/textile to a second white or un-dyed material in a solution. Testing for wet crocking to detergent type involves applying a detergent/liquid to a dyed cloth and applying the double rubs motion with a white cloth to observe unintended dye transfer.

Many pigment dyes in the related art are dyes in solutions with ammonia. When dyes are not properly handled or stored-the shelf life is very short. Additionally, the contamination of machine and environment caused by pigments are eliminated with the present invention.

### OBJECTS AND SUMMARY OF INVENTION

One object of the present invention is to provide a dye process, using large fabric dye machinery to achieve a “worn” or “weathered” look.

Another object of the present invention is to provide a simulated “pigment dye” look without the use of pigments.

Another object of the present invention is to suggest a method to use direct dyes, enhanced with a cationization process, to adhere to fibers strongly, yet not totally penetrating—allowing for a sufficient wash down capability (e.g., enzymes wash as well as a mechanical action wash) to achieve a desired “worn” look.

Another object of the present invention is to provide a process allowing for a greater range of colors, improved color consistency, less wet- and dry-crocking, as well as a very soft hand-feel while achieving superior color-fastness in use.

Another object of the present invention is to provide a dyeing process wherein the Liquid ratio is improved. In other words, a dyeing process of the present invention works with a smaller amount of water. According to the present invention, it is proposed that the recommended amount in exhaust dyeing for pigment is 15-20:1 against a previously generally recognized value of 7-12:1. It is proposed herein, that the method provides for the saving of water, energies and chemicals that ultimately reduces the cost of dyeing.

It is another object of the present invention to provide a dyeing method that minimizes changes the water-treatment system (discharge) of a manufacturer, since the treatment can be done employing Bio-logic as well as in chemicals.

The use of powder-dyes doesn't require a change in the dye-preparation area (dyeing kitchen). To work with liquid-dyes is another necessary handling step (stirring before weighing, etc).

The present invention relates to dyeing processes for fibrous materials that include treatment with a cationic agent and goods produced by such processes. The treatment permits dyeing with less dye consumption (ring dyeing). It also facilitates “wash-down” effects, which as used herein, is meant to include distressed, laundered, vintage and other wash-down appearances on fabric or other fibrous materials.

Accordingly, one aspect of the present invention is directed to a method of dyeing a fibrous material with reduced dye consumption. The method entails treating fibrous material with a cationic agent (cationic fixation or cationization), followed by contacting the treated fibrous material with a direct dye. The treatment of the fibrous material with the cationic agent allows the dye to be pulled more readily, in a controllable manner, to the fibrous material during dyeing, an advantage of which is that less dye is needed to achieve a given depth of color.

A further aspect of the present invention is directed to a method of dyeing a fibrous material to produce a wash-down look. The method entails treating fibrous material with a cationic agent, followed by contacting the treated fibrous material with a direct dye and then removing excess direct dye from the fibrous material.

A third aspect of the present invention is directed to the fibrous materials dyed in accordance with the foregoing inventive processes.

In the course of practicing the methods of the present invention, treatment of the material with a cationic agent may be preceded by one or more pre-treatments, such as scouring or bleaching, followed by neutralization. In preferred embodiments, the fibrous material includes greige goods or piece goods and the treating and dyeing steps take place in jet machines. The greige goods or piece goods may take a wide variety of forms, including cotton and cotton blends (e.g., cotton/synthetic blends and rayon blends).

The present invention provides several benefits in terms of product quality and reduced costs. Significantly, the inventive processes accommodate direct dyeing of piece goods in larger (e.g., jet) machines. These machines can process greater quantities of material than machines used in garment dyeing. The use of direct dye permits dyeing of piece goods with more consistent application of color, with a wider range of colors, more economic and enforcement friend, softer hand fell, and with improved color fastness. In addition, the direct dye process is formaldehyde-free. Cationization of the fabric readily draws dye to the fabric, so a given depth of color can be achieved with less dye, which reduces the cost of dyeing.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a graphical representation of fabric preparation, according to one aspect of the present invention.

FIG. 2 is a graphical representation of a procedure for acid-cellulase abrasion, according to another aspect of the present invention.

FIG. 3 is a graphical representation of a process wash, according to another aspect of the present invention.

FIG. 4 is a graphical representation of a procedure for a softening process, according to another aspect of the present invention.

FIG. 5 is a graphical representation of a procedure for a treatment process for light colors, according to another aspect of the present invention.

FIG. 6 is a graphical representation of a procedure for a pre-treatment process for medium and dark colors, according to another aspect of the present invention.

FIG. 7 is a graphical representation of a procedure for a dye process for light colors, according to another aspect of the present invention.

FIG. 8 is a graphical representation of a procedure for a dye process for medium colors according to another aspect of the present invention.

FIG. 9 is a graphical representation of a procedure for a dye process for dark colors, according to another aspect of the present invention.

FIG. 10 is a graphical representation of a procedure for an after treatment for medium and dark colors, according to another aspect of the present invention.

### DETAILED DESCRIPTION OF PREFERRED EMBODIMENTS

One preferred manner of performing the invention on greige goods in the form of piece goods in jet machinery is now described. Piece goods or fabric goods refer to textile products that have not yet been cut or sewn into garments or formed into sheets, pillows, etc. Typically, piece goods are sold by the piece from bolts or rolls of fabric. Jet machines generally are large, piece-dyeing machines that dye fabric in rope form. The fabric is sewn together to form a loop and the loop is run through a dyeing vessel by ropes mounted on pulleys. Jet dyeing machines are capable of dyeing up to 3000 lbs. of fabric, or more, at one time. Although large-scale dyeing machines are advantageous in that they accommodate large quantities of fabric, the present invention is not limited to the use of such machines. The techniques of this invention may also be used, for example, with garment dyeing machines.

As used herein, fibrous material refers to any material comprising fibers, regardless of the degree to which such material has been processed. Thus, fibrous materials include cottons or cotton blends (such as cotton/synthetic blends) in greige goods form as well as in other stages of processing. The materials may be in piece goods form or may already be cut and sewn (e.g., in garment form). Fibrous materials also include synthetic materials.

The term cationic agent is used herein to refer to agents that supply cations, including cationic resins and fixing agents. A preferred compound is Indosole® 50, which can be obtained from Clariant Chemical Corporation. Many other agents can be used, including resins available from various vendors, including Sandene® 8425 (available from Clariant Chemical Corporation) and GrantX® 75 (available from Grant Industries). The cationic agent imparts a positive charge to the fibers of the goods. Other forms of treatment agents are further discussed below within particular embodiments in an illustrative manner.

Treatment with a cationic agent is typically accomplished by injecting the cationic agent into the dyeing vessel through one or more injection ports. Once the cationic agent is injected, the goods are circulated in the bath or vessel until the desired degree of exhaustion (i.e., removal of the agent from the bath) of the cationic agent is achieved.

Adjustment of parameters such as temperature, pH, circulation, run time and concentration of the cationic agent during cationization facilitates an even application of the cationic agent. Optimization of these parameters is within the level of skill in the art when operating according to the disclosure herein.

The concentration of the cationic agent used may vary depending on the nature of the greige goods or other fibrous material used, the desired shade or color of the finished goods and the desired look of the goods. In general, the concentration of the cationic agent ranges from about 2% to about 8%. For lighter colors, less cationic agent is used. For darker colors, more cationic agent is used. It is proposed that employing the method disclosed herein will yield the desired results without undue experimentation.

An injection time of the cationic agent depends on several factors including the nature of the fabric or material, the machine, the rope length and pulley speed (if applicable) and the start-up temperature. Rope length refers to the length of fabric being sent through the machine. Preferably, in one embodiment, the injection time for the cationic agent is between about 20 minutes and about 40 minutes. In preferred embodiments, increasing amounts of cationic agent are injected as the process proceeds (i.e., non-linear injection).

An appropriate water ratio for the cationization process depends upon the machine use. The water ratio is a ratio of the mass of the fabric to the mass of the bath in which the goods are held. A preferred ratio range is about 1:5 to about 1:20, and more preferably from about 1:5 to about 1:15, but variation will occur depending upon the other parameter's noted herein and an optimum level may be determined without undue experimentation.

A preferred pH range for the general cationization step is about 5.5 to about 6.5. Buffers and other means may be used during cationization to maintain a more stable pH throughout the process as cationic agent is added to the bath. When alkaline cationic agents are used, it is preferable to begin cationization at an acidic pH.

In a preferred embodiment, the bath is heated during the course of cationization from a starting temperature to an end temperature. The starting temperature, which, in a preferred embodiment, remains constant during injection, depends on the machine used, the speed at which the machine is run and the nature of the fabric or material. A range of between about 80-120° F. has been found to be effective as a starting temperature for treatment of greige goods in jet machinery. The bath may then be heated, with a preferred heat-up rate of about 2-4° F. per minute. In one preferred embodiment, the bath is heated to an end temperature of around 140° to around 180° F. and the process continued at that temperature. The process is run until the desired exhaustion of the cationic agent is achieved.

Following the desired degree of exhaustion of the cationic agent, the user typically opens a drain in the dyeing vessel to release the remaining contents of the bath. At around the time of opening the drain, the operator may also employ an overflow process, in which cold water is added to the bath to offset drainage of water and to slowly lower the temperature of the water. The goods are then usually rinsed with water or fixed in an additional step or series of steps.

Typically, to begin the dye process, the machine is filled with water and dye is injected into the dyeing vessel through one or more injection ports. The process is run until the desired degree of exhaustion of the dye is achieved.

According to the present process, the direct dye used is less positively charged than the treated fibrous material. Because of this, the dye is drawn to the positively charged surface of the material. The greater the positive charge on the material, the greater the attraction between the dye and the material, and the more quickly the dye in the bath is exhausted. Direct dyes generally exit, but have been unused in the process described. Thus, after reasonable experimentation, a skilled artisan may select a direct dye for any given application according to the present method.

Treatment with a cationic agent permits the operator to obtain a given depth of color with less dye, which offers cost savings. Wash-down effects (e.g., distressed, laundered or vintage looks), for example, can be achieved with less dye (e.g., between 70% and 90% less dye) than is used in pigment or sulfur processes. The savings is not limited, however, to goods with wash-down effects, but rather applies to any goods produced with direct dye following treatment with a cationic agent in accordance with the invention.

The process parameters for the direct dyeing depend on the desired color of the finished goods. Adjustment of parameters such as water ratio, temperature, pH, electrolyte content of the bath, use of leveling or blocking agents or retarders, use of fixing agents and run time to achieve desired results is within the level of skill in the art.

The appropriate water ratio prior to injection of the dye depends on the machine used. A preferred water ratio is between about 1:7 and about 1:15 as earlier noted, although nothing prevents the present method from being employed in other reasonable manners with different ratios.

For light to medium colors, techniques may be employed to prevent too rapid an adhesion of the dyestuff onto the fabric, allowing more consistent dye exhaustion and coloring of the fabric. Where electrolytes such as calcium are present in the water (e.g., “hard water”), water softeners, such as sequestering agents, can be used to reduce the level of electrolytes in the water. Leveling, dispersion, and blocking agents or retarders may also be used to facilitate slower release of dyestuff onto the material. An alkaline pH may also be used to further block the dyestuff from adhering too quickly to the material.

On the other hand, to “harden” the water, electrolytes such as calcium chloride or sodium chloride may be added to the bath. Adding these compounds places more electrolytes in solution and allows the dye to adhere to the fabric more quickly. By adjusting the level of electrolytes, a user can control exhaustion of the bath and control the consistency of color from batch to batch.

For dark colors, other techniques may be employed to permit more rapid adhesion of the dyestuff onto the fabric. An acidic pH, for example, may be used during dyeing to facilitate exhaustion of the dyestuff. The fabric or other material may be circulated in a buffer of pH 5.5, for instance, prior to injection of dye. If the dye in the bath has not been sufficiently exhausted, sodium sulfate, sodium chloride, or calcium chloride may be used to add electrolytes to solution, which pulls the dye onto the fabric more quickly.

Temperature may also be adjusted during dyeing to control the rate of dye exhaustion and the penetration of dye into the goods. In general, the higher the temperature, the more quickly the dye is exhausted. Adjusting the temperature also may facilitate obtaining desired characteristics of the finished goods (including, for example, certain wash-down effects) during wash down. As in the case of cationization, the dyebath may be heated from a starting temperature to an end temperature. In one preferred embodiment, the starting temperature is between about 90° and about 110° F., the heat-up rate is about 2° to about 4° F. per minute and the end temperature is between about 150° F. and about 180° F. (note or the related equivalents in the Celsius scale as noted on the later figures). The process is run until the desired exhaustion of the dye is achieved.

When the appropriate level of dye exhaustion is achieved, the user typically opens a drain in the dyeing vessel to release the contents of the bath. At around the time of opening the drain, the operator may also employ an overflow process with cold water. The goods are then usually rinsed until there is little or no dyestuff left in the bath.

For dark colors, to prevent excessive migration of color after dyeing while the wet material remains in the machine, a fixing agent may be applied to the goods. The fixing agent is preferably formaldehyde-free, such as Tinofix® (available from Ciba-Geigy) or Grantfix® (available from Grant Industries). The fibrous material is circulated in a bath containing the fixing agent, the vessel is drained and the goods are rinsed.

Following dyeing, an operator may employ a finishing process, which may include extraction, softening, drying, framing, compacting, napping, etc. The goods may then be cut and sewn into garments, pillowcases, etc.

A wash-down process is then performed to remove excess dye from the goods. During wash-down, the removal of dye may create wash-down appearances, including distressed, vintage and laundered looks. While not intending to be bound by any particular theory of operation, it is believed that treatment with a cationic agent facilitates removal of dye to create better wash-down effects than other dye processes.

A number of different techniques for removal of excess dye (wash-down processes) may be used to arrive at different appearances of the goods, e.g., vintage, distressed, enzyme-washed, laundered, etc. Wash-down processes include the use of acid enzymes, detergents, stonewashing, phosphates, neutral enzymes, etc. Neutral enzymes can be used for a “softer” wash-down. Acid enzymes, detergents and stonewashing tend to create a more distressed look. Adjustments to such wash-down processes, including adjustments to the chemicals used, concentrations of chemicals, time, temperature, type of machine used, speed of machine, load in the machine, etc., are within the skill in the art.

Following wash-down, a softener may be optionally applied to the goods. Depending on the desired “hand” of the finished goods, an operator may select from a number of different agents, including cationic, nonionic and silicone softeners. Following application of a softener, the goods typically are dried, steamed and packaged.

In a preferred embodiment of the methods of the present invention, the cationization and direct dyeing steps are preceded by one or more pre-treatment steps to remove impurities from the fibrous material (particularly in the case of greige goods which are unbleached or un-dyed goods). Such impurities include oils, waxes, paraffin, yarn dust, etc. These procedures typically involve scouring or pre-bleaching followed by neutralization and is conducted in accordance with standard procedures in the dyeing art. Pre-treatment processes include the use of peroxide, alkaline solutions or enzymes. Persons of skill in the art may employ pre-bleaching using peroxide to render greige goods white, particularly for items that ultimately will be of a light color. Another method of pre-treatment is scouring the material using a caustic or high-alkalinity agent in the absence of peroxide or bleach. This technique is often used for items that will be of a medium or dark color.

Pre-bleaching or scouring is typically followed by neutralization, during which the pH of the fibrous material is adjusted to a more neutral level. In a preferred embodiment, the pH is adjusted to between about 6 and about 7. The pre-bleached or scoured goods typically are first rinsed and the liquid is drained. If the goods were at an alkaline level following pre-bleaching or scouring, an acid, such as acetic acid, can be added to neutralize the pH. If peroxide was used during preparation, bisulfide can be used to reduce the peroxide. Enzymes can also be used for neutralization. The goods may then be subjected to treatment, dyeing and wash-down.

According to the present method employing the disclosed “colortex-effect”, selected direct colors are chosen. Preferred are dyestuffs with high-light fastness (Cu-complex) wherein in the process discussed (cationization), the light-fastness will drop more or less one point. For example, color selection=4-5 for 20 hours, whereas with the present cationization process 3-4 in 20 hours. Colors recommended from Ciba-Geigy or others are as follows
Solophenyl-Yellow ARELE
Solophenyl-Orange ARLE
Solophenyl-Orange TGL
Solophenyl-Brown AGL
Solophenyl-Brown RL
Solophenyl-Bordeauz 3BLE
Solophenyl-Violet 4BLE
Solophenyl-Blue TLE
Solophenyl-Blue FGLE
Solophenyl-Grey 4GLE
Solophenyl-Navy BLE

The following broad parameters and general suggestions are discussed to aid the user of the claimed methods herein.
1. Solubility (g/l): To prepare and dissolve Directcolors check the solubility from each color. For example, For dyeing 1000 kg with the amount of 1.2% dyestuff and the solubility is at 50 g/l, the minimum water necessary is:
   ((1000×1.2)/100)*(1000/50)=240 liters of water
To prevent the risk of not dissolving the dyestuff 100%, inject the color in to the dyeing machine in at least two parts.
2. Water: Work with soft water. Do not use sequestering-agent EDTA-Types as an aid. These types remove the Cu-complex in the colors and the light fastness will drop sharply.
3. Machine: For the dye-process discussed herein, a water ratio of about 1:7 to about 1:15 is used (although wider ratios are possible with more controlling agents), and preferably a ratio from 1:7 to about 1:10, depending upon the type of machine and material employed.
4. Chemicals: Use only non-or low-foaming chemicals. Do not use antifoam agents with a silicon type base. Work only with non-formaldehyde base chemicals. Employ through the different combinations suggested herein, only cationic and not ionic operant products. While these general parameters provide only a guideline enabling broad adaptation of the present invention, the will aid the user in achieving a
5. Fabric Preparation: Greige goods have to be prepared for dyeing. Suggested, but not mandated, are a pre-bleach with peroxide for all shades. After this process it is recommended that a user check for peroxide neutralization and a pH of roughly 6.5-7 as a general guide.

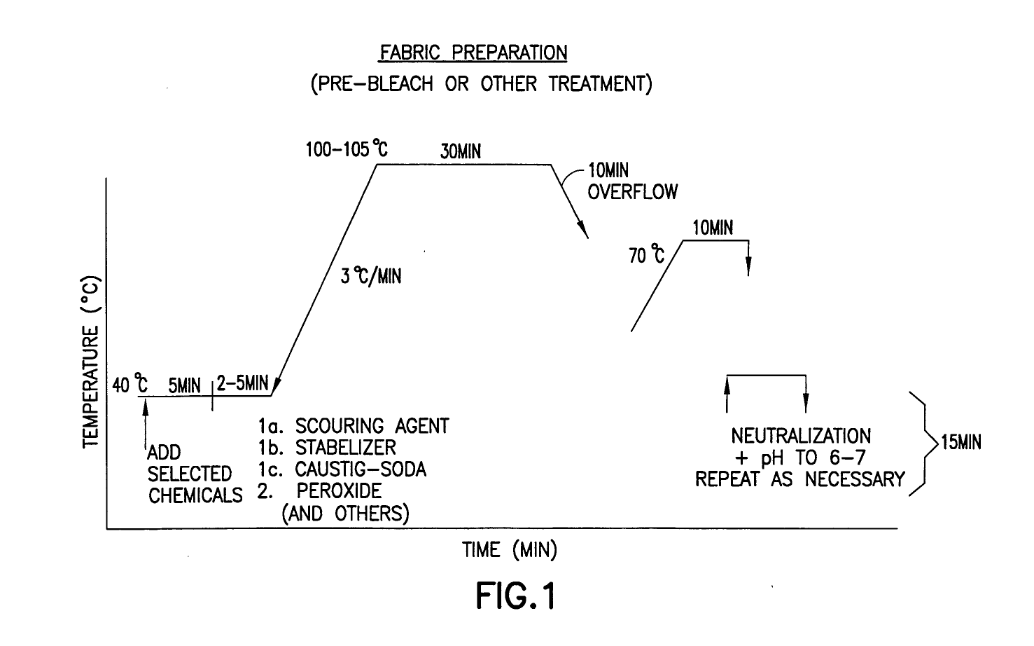

Referring now to FIGS. 1-10, and with the suggestions above fully in mind, the following are examples of the present invention. It should be understood, that FIGS. 1-10, are only representative of the below-described procedures, are descriptive in nature, and should not be understood as a specific, mandated, and sole method to achieve the present embodiments.

As used herein, it should be understood, that by exhausting a cationic polymer onto or into the fabric, we increase the affinity of the fabric for a direct dye. The effectiveness of different cationic polymers shows, that some products are much better suited then others for this cationic exhaustion or treatment process. While the present method does not mandate particular agents for cationization or dyeing, preferred agents include Grandex 640, alone or in combination with Granterg LF40 (or others available from Grant Industries, Inc.). The amount of agent (Grandex 640) used is dependent upon a desired depth of color.

For light colors, colors from about 0.01% to about 0.45%, the treatment is done after dyeing and the use of 1% Grandex 650 is recommended in one embodiment.

For medium colors, colors from about 0.45% to about 1.0%, the treatment is applied before dyeing, and the use of 1.8% Grandex 640 with 0.35% Grandterg LF40 is recommended in one embodiment.

For medium to dark colors, colors from about 1% to darker, the treatment is applied before dyeing, and the use of 2.8% Grandex 640 with 0.35% Grandterg LF40 is recommended in one embodiment.

In one present embodiment, to achieve a distressed or warn appearance, an abrasive process is employed after the cutting and sewing, and within a washing step. Within the washing step, a rotary drum machine is employed and different combinations of chemicals, times for washing, machine speeds, and chemical/water ratios are employed depending upon a desired look.

Referring now to FIG. 1, a representative example of a fabric preparation procedure is provided enabling a user to select desired chemical for scouring, stabilizing, bleaching, etc., in order to prepare the fabric for the below described treating and dyeing processes. While a high temperature of roughly 100-105° C. is discussed, this temperature and the other temperatures (and durations) discussed are meant to be illustrative only and not limiting or controlling factors, as long as a desired condition is met. E.g., a pre-bleach treatment is conducted and then neutralized.

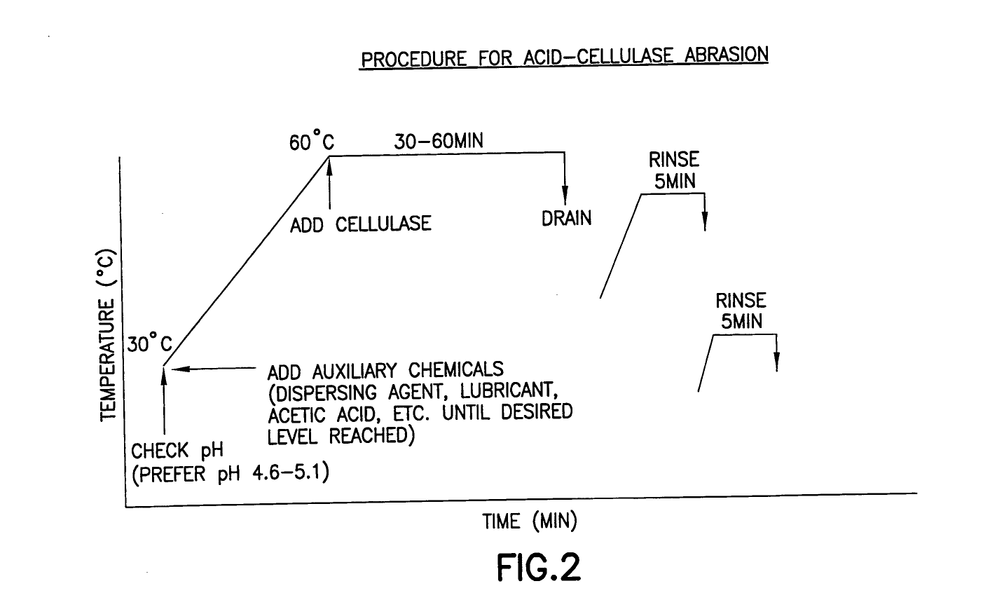

Referring now to FIG. 2, a representative procedure for an acid-cellulase abrasion treatment. The following are steps in the representative procedure within generally a rotary machine: (1) set bath at 30C, (2) select and set auxiliary chemicals (dispersion agents, lubricants, acetic acids, etc. until a desired level is reached), (3) check for a desired pH level, preferably in the 4.5-5.1 range, (4) raise temp to 60C, (5) add cellulase enzyme (depending upon a desired degree of wash down from approximately 1% to 2%, (6) circulate the batch for 30-60 minutes (depending upon degree), (7) drain the machine, (8) rinse for 5 to 10 minutes at a desired temp, (9) drain the machine, (10) rinse in cold water for 5 minutes, and (11) drain again.

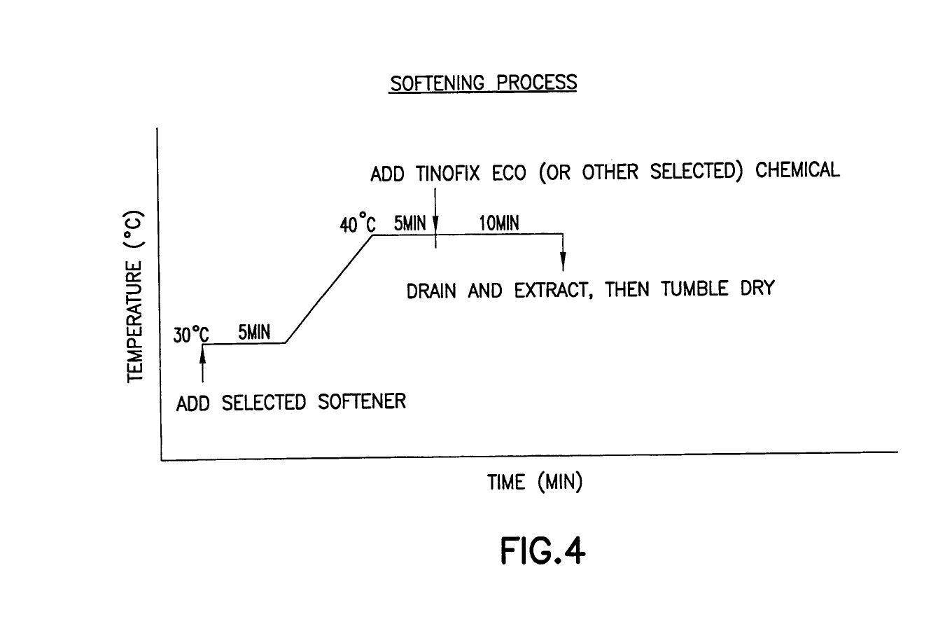

Referring now to FIG. 4, an additional softening process may be employed in addition to the abrasion treatment of FIG. 2, or in a separate step. As generally represented, the softening process of FIG. 4 includes the following steps: (1) set bath at 30C, (2) add a selected softener (cationic, non-ionic, or a silicon softener), (3) circulate for 5 min, (4) raise temperature to 40C, (5) circulate for 5 min, (6) add Tinofix ECO or other selected chemical, (7) circulate for 10 min, (8) drain and extract then tumble dry.

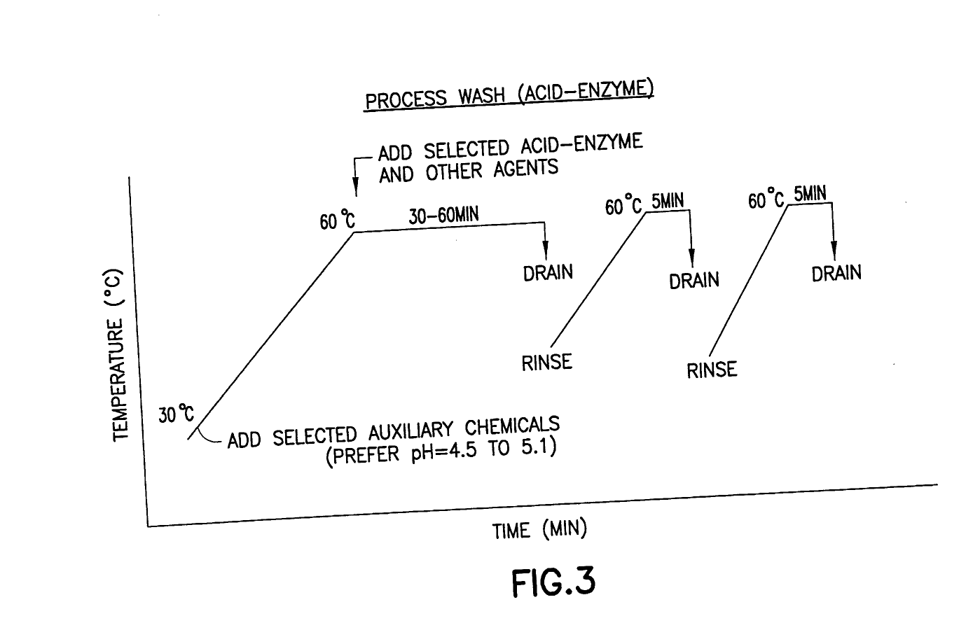

Referring now to FIG. 3, an optional process wash (acid-enzyme) is discussed separate from or in addition to the softening process wash discussed in FIG. 4. According to the representations made in FIG. 3, one example of a process wash would include the following steps: (1) set the bath at 30C, add selected auxiliary chemicals, and adjust the pH to a desired level, generally 4.5 to 5.1 for an acid-enzyme process wash, (2) raise the temperature to 60C, (3) circulate for 30 to 60 minutes while adding any other selected processing chemicals or agents to aid the acid-enzyme process wash, (4) drain, (5) rinse at 60C for five minutes and drain, and (6) rinse at 60C and drain to end the acid-enzyme process wash.

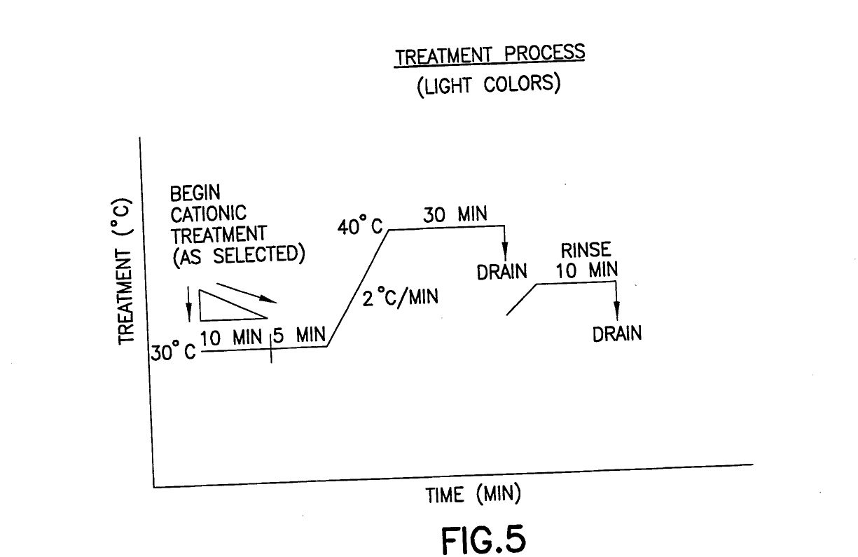

Referring now to FIG. 5, a cationic treatment for light colors (with Grandex 640 or other agent) after dyeing is represented and includes generally the following steps: (1) setting the bath at 30C, (2) adding Grandex 640 over 10 minutes, (3) circulating for 5 min, (4) heating at 2-3C/min to 40C, (5) circulating for 105 min, (6) drop, (7) rinse for 10 min, (8) and drop again.

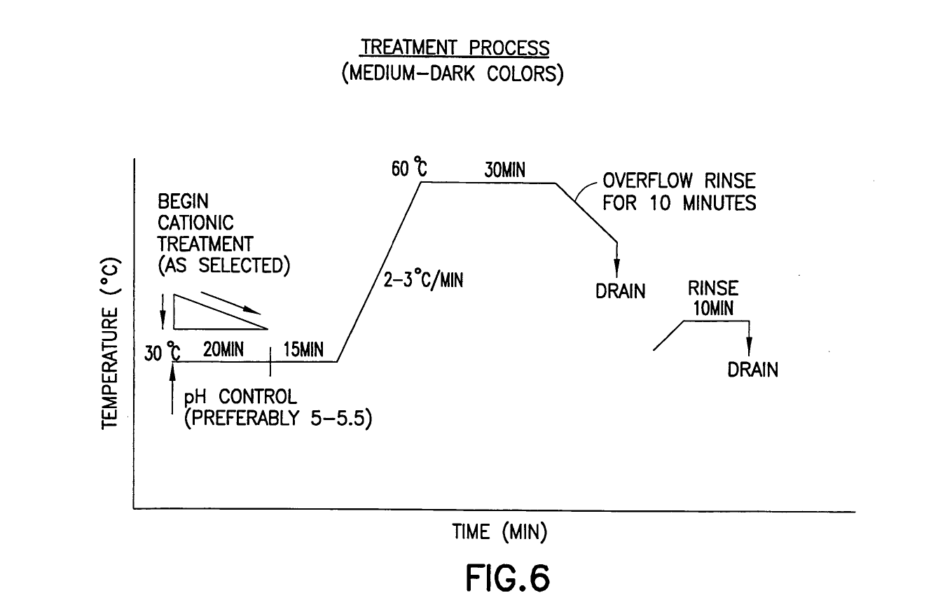

Referring now to FIG. 6, a cationic treatment (with Grandex 640 or other agent) for medium to dark colors is discussed before dyeing, and includes generally the following steps: (1) set bath at 30C, (2) add Grandex 640 and Grandterg LF40 over 20 minutes, (3) circulate for 15 min, (4) heat up at 2-3C/min to 60C, (5) circulate for 30 min, (6) overflow rinse for 10 min, (7) drop, (8) rinse for 10 min, and (9) drop again.

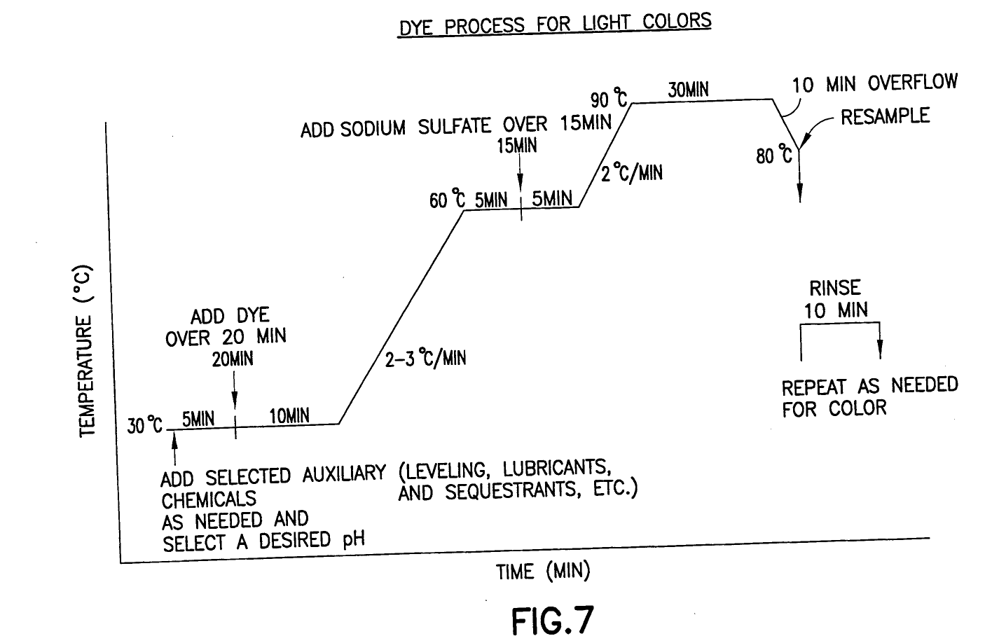

Referring now to FIG. 7, a dye process for light colors is provided and includes generally the following steps: (1) set bath at 30C, (2) add auxiliary chemicals as desired (leveling, lubricating, sequestering, etc.), (3) circulate for 5 min, (4) add a selected dye slowly over 20 min, (5) circulate for 10 min, (6) raise temp at 2-3C/min to 60C, (7) circulate for 5 min, (8) add sodium sulfate over 15 min, (9) circulate for 5 min, (10) raise temp at 2C/min to 90C, (11) circulate for 30 min, (12) cool-down to 80C, (13) check sample (conduct additional sampling as desired), (14) overflow for 10 min, (15) drop, (16) rinse for 10 minutes, (and (17) drop again.

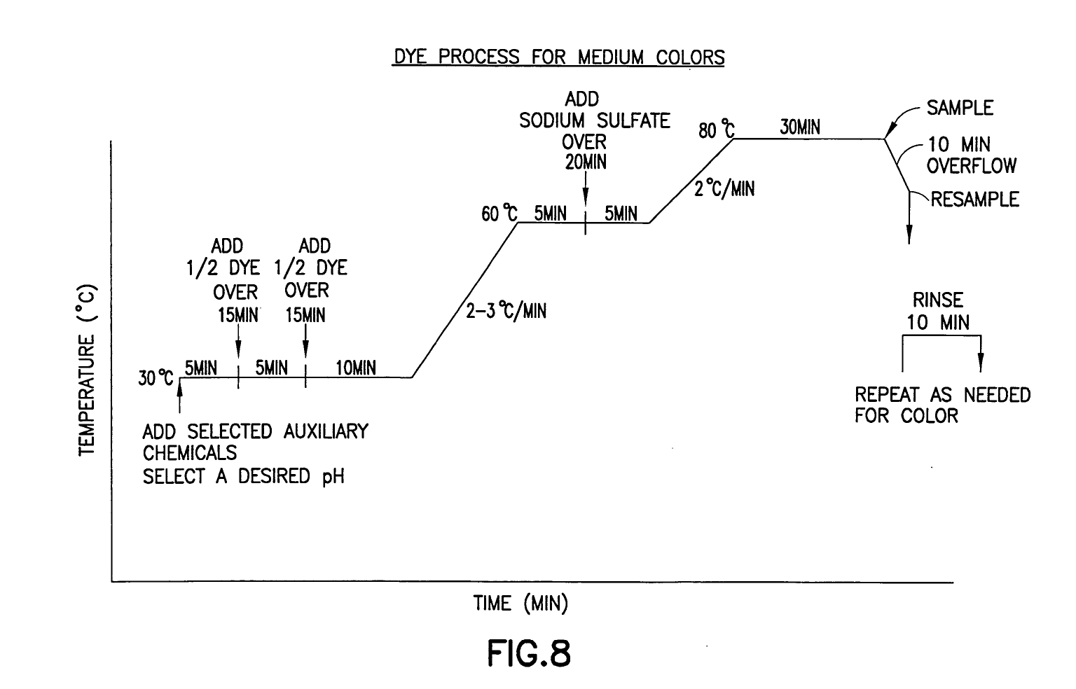

Referring now to FIG. 8, a dye process for medium colors is provided and includes generally the following steps: (1) set bath at 30C, (2) add auxiliary chemicals (Gransperse CTA, Sequestrente, etc.), (3) circulate 5 min, (4) add selected dyes slowly over 15 minutes (part 1), (5) circulate 5 min., (6) add dyes slowly over 15 minutes (part 2), (7) circulate 10 min, (8) raise temp at 2-3C/min to 60C, (9) circulate 5 min, (10) add sodium sulfate over 20 min, (11) circulate 5 min, (12) raise temperature 2C/min to 80C, (13) circulate for 30 min, (14) check sample (resample as needed), (15) overflow for 10 min, (16), drop, (17) rinse for 10 min, (18) drop.

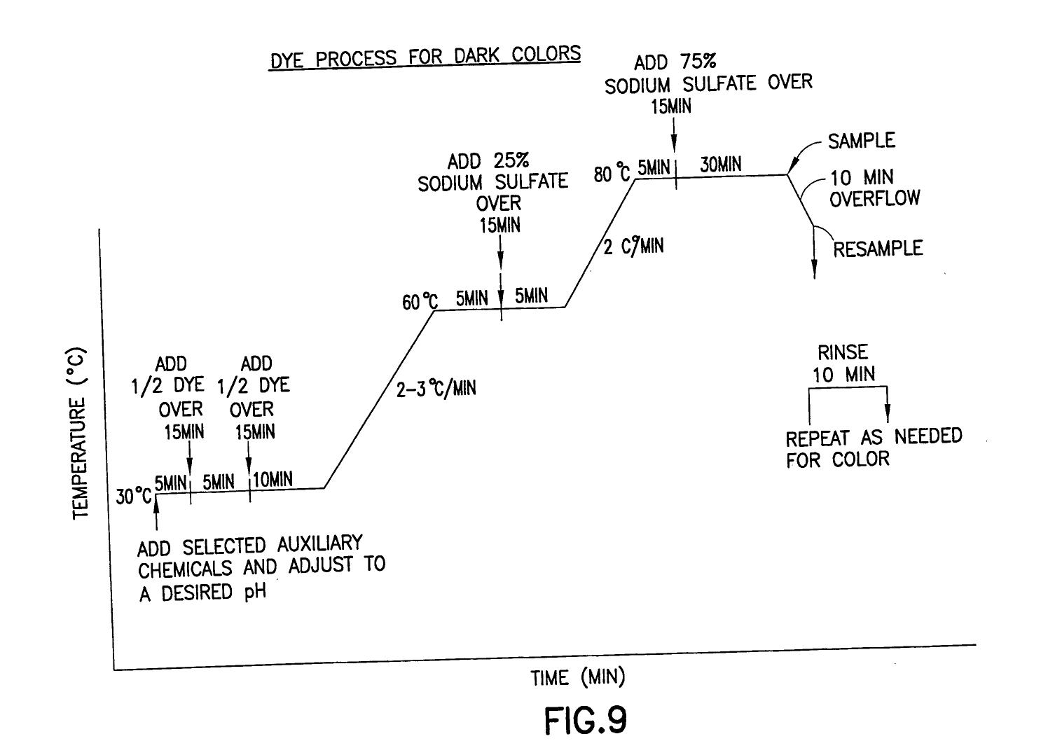

Referring now to FIG. 9, a dye process for dark colors is provided and includes generally the following steps: (1) set bath at 30C, (2) add auxiliary chemicals (Gransperse CTA, Sequestrente, etc.), (3) circulate 5 min, (4) add selected dyes slowly over 15 minutes (part 1), (5) circulate 5 min., (6) add dyes slowly over 15 minutes (part 2), (7) circulate 10 min, (8) raise temp at 2-3C/min to 60C, (9) circulate 5 min, (10) add sodium sulfate over 15 min (25% of total amount), (11) circulate 5 min, (12) raise temperature 2C/min to 80C, (13) circulate for 5 min, (14) add sodium sulfate over 15 min (75% of total amount), (15) circulate for 30 min, (16) check sample (resample as needed), (17) overflow for 10 min, (18), drop, (19) rinse for 10 min, (20) drop, (21) rinse for 10 min, and (22) drop.

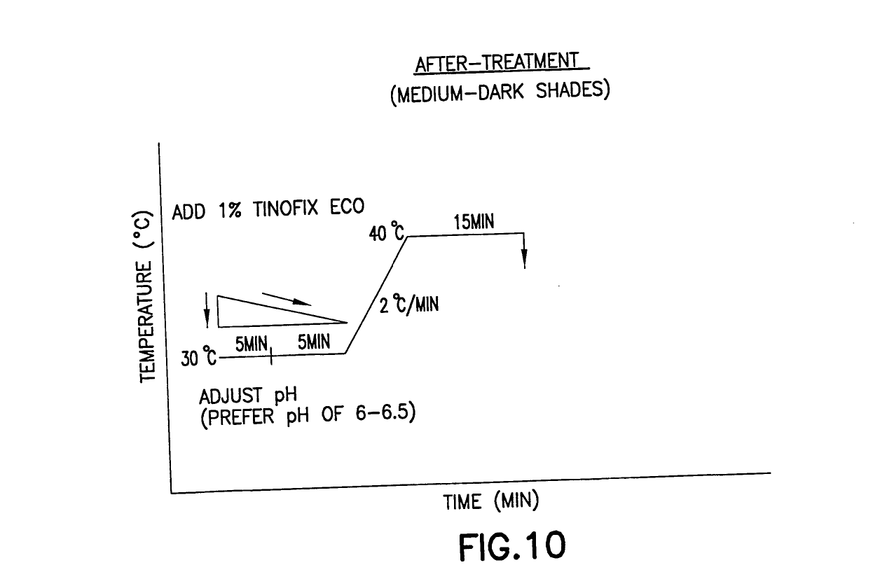

Referring now to FIG. 10, an after treatment, with a fixing agent to prevent dye migration for medium and dark shades, may be necessary. As noted above, it is recommended to use a formaldehyde-free fixing agent (recommend Tinofix Eco from Ciba-Geigy). The following steps are suggested: (1) set bath at 30C, (2) add 1% Tinofix ECO over 5 min to a preferred adjusted pH of 6-6.5 over 5 min, (3) circulate for 5 min, (4) raise temperature at 2C/min to 40C. (5) circulate for 15 min, and (6) drop.

During the above suggested dye processes, it is optionally possible to employ an acid-aid, a salt, sulfate, calcium, or other agent for improved exhaustion. It should also be understood, that more than one salt may be used in the dyeing processing depending upon the dye shade and type employed. Obviously, the number and temperature of the rinse cycles should be adjusted to achieve a desired result.

As a further comment, it should be well understood by those skilled in the art that the discussed graphical representations and steps provided are exemplary only, and that in employing the present method adjustments may be necessary for the size of machine used, the type of machine, the speed of the pulley for fabric movement, the type of fabric, and many other factors.

It should be further understood, that the process variables noted above may be varied upon a desired type of end result, soft or heavy distress, the type of container, the type of enzyme (liquid, powder, acid, neutral), and many other factors.

It is to be understood that the above description is provided by way of example only. Various details may be modified without departing from the spirit and scope of the invention. In particular, it should be noted that the appropriate procedures for performing any given dye process within the scope of the invention will depend on many factors, including the type of machine used, the speed of the machine (e.g., the RPMs for a pulley in a jet machine), the rope length, the desired color (e.g., light vs. dark), the dye materials used, the starting and ending temperatures, heat-up rates, pH, the presence of electrolytes, water ratio and time. Persons of skill in the art familiar with dye processes can readily adjust these parameters to achieve their desired results.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the spirit and scope of this invention as defined in the following claims.

1. A method for dyeing a fibrous material, comprising the steps of:
treating fibrous material with a cationic agent; and
contacting the treated fibrous material with a direct dye, wherein the direct dye adherence to said fibrous material is improved while dye over-penetration is minimized resulting in a more uniform coloring with improved transfer resistance and reduced dye requirements.

2. A method of claim 1, wherein said fibrous material further comprises:
at least one of a greige good, a piece good, a cotton good, a cotton/synthetic blended good, and a synthetic good, whereby said method enables ready adaptation to a variety of fibrous materials while improving the available range of acceptable colors, minimizing undesirable wet and dry crocking, enabling an undesirable soft feel, and enabling a desired distressed appearance.

3. A method according to claim 2, wherein:
said steps of treating and contacting are performed in a jet machine.

4. A method according to claim 3, further comprising a step of:
conducting at least one pre-treatment of said fibrous material prior to said step of treating.

5. A method according to claim 4, wherein:
said step of conducting at least one pre-treatment further comprises a step of scouring said fibrous material.

6. A method according to claim 4, wherein:
said step of conducting at least one pre-treatment further comprises a step of bleaching said fibrous material.

7. A method of according to claim 5, wherein:
said step of conducting at least one pre-treatment further comprises a step of neutralizing said fibrous material after said step of scouring said fibrous material.

8. A method of according to claim 6, wherein:
said step of conducting at least one pre-treatment further comprises a step of neutralizing said fibrous material after said step of bleaching.

9. A method for dyeing a fibrous material, comprising the steps of:
treating the fibrous material with a cationic agent;
contacting the fibrous material with a direct dye; and
removing an excess direct dye from the fibrous material, whereby said fibrous material is dyed with an improved dye adherence enabling an improved range of colors.

10. A method according to claim 9, wherein:
said fibrous material further comprises greige goods, and said greige goods further comprise at least one of a piece good, a cotton good, a blended cotton/synthetic good, and a synthetic good.

11. A method according to claim 10, wherein:
said steps of treating and contacting are performed in a jet machine.

12. A dyed product made according to the method of claim 9, wherein:
said fibrous material has a wash-down appearance.

13. A method according to claim 10 further comprising:
at least one step of pre-treating said fibrous material prior to said step of treating of the material with a cationic agent; and
said step of pre-treating further comprises at least one of a step of scouring, a step of bleaching, and a step of neutralizing said fibrous material.

14. A method according to claim 13, wherein:
said at least one step of pre-treating includes said steps of neutralizing said fibrous material after conducting said step of scouring.

15. A method according to claim 13, wherein:
said at least one step of pre-treating includes said steps of neutralizing said fibrous material after said step of bleaching.

16. A method for dyeing greige goods, comprising the steps of:
at least one of a scouring and a bleaching of said greige goods;
neutralizing the at least one of a scoured and a bleached greige good;
treating said neutralized greige goods with a cationic agent;
contacting said greige goods with a selected direct dye; and
removing excess direct dye from the greige goods, thereby producing a greige good with a wash-down look.

17. A system for dyeing fibrous goods, comprising:
means for pre-treating said fibrous goods with at least one of a scouring, a bleaching, a distressing, and a cleaning process;
means for neutralizing said fibrous goods after said means for pre-treating conducts said one of a scouring, a bleaching, and a cleaning process;
means for treating said neutralized fibrous goods with a cationic agent, whereby an electronic charge of said fibrous goods is increased;
means for selecting a direct dye, whereby said selected direct dye is compatible with said cationic treated fibrous goods;
means for contacting said fibrous goods with said selected direct dye; and
means for removing an excess of said direct dye from said fibrous goods, thereby producing a dyed fibrous good.
